(19) United States
(12) Patent Application Publication
(10) Pub. No.: US 2023/0214413 A1
(43) Pub. Date: Jul. 6, 2023

(54) INFORMATION RECOMMENDATION SYSTEM, INFORMATION SEARCH DEVICE, INFORMATION RECOMMENDATION METHOD, AND PROGRAM

(71) Applicant: NIPPON TELEGRAPH AND TELEPHONE CORPORATION, Tokyo (JP)

(72) Inventors: Takeshi KUGIMOTO, Musashino-shi, Tokyo (JP); Osamu KAMATANI, Musashino-shi, Tokyo (JP); Takahiro YAMAGUCHI, Musashino-shi, Tokyo (JP)

(73) Assignee: NIPPON TELEGRAPH AND TELEPHONE CORPORATION, Tokyo (JP)

(21) Appl. No.: 18/008,643

(22) PCT Filed: Jun. 11, 2020
(86) PCT No.: PCT/JP2020/022960

§ 371 Date: Dec. 6, 2022

(51) Int. Cl. G06F 16/335; G06F 40/35; G06F 40/247; G06F 40/279; G06F 16/36

(52) U.S. Cl. CPC G06F 16/335; G06F 40/35; G06F 40/247; G06F 40/279; G06F 16/374

(57) ABSTRACT

An objective of the present disclosure is to allow a situation in a conversation of a user to be recognized as a context and allow an item appropriate for the situation to be presented. An information recommendation device according to the present disclosure includes a context extraction module 24 that extracts, from the conversation of the user, a keyword representing a topic, a similarity determination module 31 that refers to a knowledge base 13 storing recommended items linked to communication contexts each including the keyword to extract the recommended items and the communication contexts that are linked to the extracted keyword and selects, from among the extracted communication contexts, the communication context similar to the topic, and an information search module 32 that acquires, from the knowledge base 13, the recommended item linked to the selected communication context.

### TECHNICAL FIELD

The present disclosure relates to communication, information communication, and a database operation instruction.

### BACKGROUND ART

Remarkable progress of ICT in recent years allows a communication network that has been targeted at only voice communication using a telephone or the like to handle various media such as a video, an image, and a text message. In particular, prevalence of smartphones has significantly changed how to communicate, and it is possible to share various information related to a communication partner and perform communication in real time. In addition, a user selects, from among a huge number of contents circulating on a network, a content that interests the user and shares information about a content that may also be of interest to the communication partner through a social network service or the like.

While objective information is exchanged mainly via text messages, it is becoming increasingly important to share subjective information and feelings in order to improve the quality of interpersonal communication. Through mutual sharing of thoughts and feelings, communication partners can obtain mental satisfaction by expressing sympathy to each other. Subjective information and feelings are mostly shared through communication without a clear purpose, such as chatting, not through communication with a clear purpose, such as a meeting. Since chatting is non-goal oriented communication, a topic for a conversation is optionally selected by a speaker. However, there are cases where an appropriate topic does not immediately come to mind and where the selected topic does not activate a mutual dialogue. From this viewpoint, there is a need for a method of providing appropriate topics and information in interpersonal communication to activate the communication. For example, in communication via text messages, there is a need for a method of providing information such as knowledge, news, topics, and video contents that are appropriate for what is being discussed in the dialogue and promote the communication.

As a means for retrieving appropriate information from a huge number of contents and providing the retrieved information, there is an information recommendation system (NPL 1) and, since the advent thereof in 1990s, various information recommendation systems have been studied and put to practical use. For example, information recommendation systems are used in online shopping, content distribution services such as music distribution and movie/video distribution and the like. In the information recommendation systems, methods such as cooperative recommendation, content-based recommendation, and knowledge-based recommendation are known as conventional technologies and, to effect more accurate recommendation, a hybrid approach using various methods in combination is considered to be effective. In addition, a system that recommends information by adapting to a situation (context) in which the recommendation system is used or a situation (context) of a user has also been progressively studied, and is referred to as a context-aware recommendation system. The context mentioned herein is a situation parameter that can be acquired by the system and is likely to affect selection and ranking of recommendation information (a recommended item). Examples of the context include location information, time, weather, lighting, a noise level, a stock market, a sport score, a health condition, feelings, a schedule, an activity state, a group activity, information about people in the same room, a network traffic, a printer state, and the like.

### CITATION LIST

### Non Patent Literature

[NPL 1] “Recommender Systems: An Introduction”, translation supervised by Katsumi Tanaka and Kazutoshi Sumiya, Kyoritsu Shuppan Co., LTD., 2012
[NPL 2] RDF 1.1 Concepts and Abstract Syntax, W3C Recommendation 25 Feb. 2014, https://www.w3.org/TR/rdf11-concepts/. (retrieved May 24, 2020)
[NPL 3] OWL 2 Web Ontology Language Document Overview (Second Edition), W3C Recommendation 11 Dec. 2012, https://www.w3.org/TR/owl2-overview/. (retrieved May 24, 2020)
[NPL 4] SPARQL Query Language for RDF. W3C Recommendation, January 2008, https://www.w3.org/TR/rdf-sparql-query/. (retrieved May 24, 2020)
[NPL 5] SPIN (SPARQL Inference Notation), http://spinrdf.org/. (retrieved May 24, 2020)

### SUMMARY OF THE INVENTION

### Technical Problem

However, it is difficult to apply a conventional information recommendation technology, which has been developed mainly for the purpose of guiding people to purchase, to a method of providing appropriate topics and information in interpersonal communication to activate the communication. In addition, while it is known that hybrid processing obtained by combining a plurality of methods is performed in the conventional information recommendation technology intended for purchasing, music, and the like, how to apply the hybrid processing to topic and information provision in interpersonal communication and how to combine and use the plurality of methods has not been fully disclosed.

It is not easy for a computer to intervene in person-to-person communication and provide appropriate information according to details of a conversation. One of the reasons for this is that it is difficult for the computer to accurately recognize the meaning of a conversational text. In the person-to-person communication, it is rare that the topic being discussed is clearly shown during the conversation. Therefore, using techniques such as text mining, the computer analyzes the conversation without entering into the meaning of the conversational text and estimates what category is being discussed or what keywords are representative of a flow of a conversation. When the category and keywords of the conversation can precisely be identified, it is possible to provide more accurate information by using these category and keywords to search a recommendation information database.

However, in most of current topic extraction techniques, topic categories are not so specifically classified and, even when category information is used, information to be recommended cannot be retrieved with high accuracy. Needless to say, this does not mean that the category information is completely useless, and the category information can be used in selecting a database to be used from among various types of recommendation information databases or for narrowing down a search result. In addition, by using a keyword extraction technique, it is possible to obtain one of nouns and the like included in a conversation that accurately represents the topic thereof.

However, there is a first problem that it is difficult to obtain a search result when the same keyword as that obtained by using the keyword extraction technique described above is not included in an index of the information recommendation database.

In addition, each of messages in a conversation is typically short, and a sufficient amount of information may not be obtained from the message. In such a case, a keyword that can be used as a clue for an information search may not be obtained at all. In other words, the keyword extraction technique described above has a second problem that it is difficult to obtain a search result when the conversation is short.

To solve the problems described above, it is therefore an object of the present invention to provide an information recommendation system, an information search device, an information recommendation method, and a program that allow information to be searched for even when a keyword cannot be obtained directly from a conversation of a user.

### Means for Solving the Problem

To attain the object described above, the information recommendation system according to an aspect of the present invention generates, from a keyword included in a conversation, synonyms including a synonymous word, an analogous word, a related word, a superordinate word, a subordinate word, an association word, and the like of the keyword of concern, and searches for information using a group of keywords including these. It is assumed that the wording “synonyms” or “synonyms and the like” used in this description includes the synonymous word, the analogous word, the related word, the superordinate word, the subordinate word, the association word, and the like.

Specifically, an information recommendation system according to an aspect the present invention includes: a knowledge base storing recommended items linked to communication contexts each including a keyword; a context extraction module that extracts, from a conversation of a user, the keyword representing a topic and searches a thesaurus database for the keyword to generate a group of keywords including synonyms of the keyword; a similarity determination module that inquires of the knowledge base about the keywords included in the keyword group to extract the recommended items and the communication contexts that are linked to the keywords included in the keyword group and selects, from among the extracted communication contexts, the communication context similar to the topic; and an information search module that acquires, from the knowledge base, the recommended item linked to the selected communication context.

An information search device according to an aspect of the present invention includes: a context extraction module that extracts, from a conversation of a user, a keyword representing a topic and searches a thesaurus database for the keyword to generate a group of keywords including synonyms of the keyword; a similarity determination module that inquires of a knowledge base storing recommended items linked to communication contexts each including the keyword about the keywords included in the keyword group to extract the recommended items and the communication contexts that are linked to the keywords included in the keyword group and selects, from among the extracted communication contexts, the communication context similar to the topic; and an information search module that acquires, from the knowledge base, the recommended item linked to the selected communication context.

An information recommendation method according to an aspect of the present invention includes: storing, in a knowledge base, recommended items linked to communication contexts each including a keyword; extracting, from a conversation of a user, the keyword representing a topic and searching a thesaurus database for the keyword to generate a group of keywords including synonyms of the keyword; inquiring of the knowledge base about the keywords included in the keyword group to extract the recommended items and the communication contexts that are linked to the keywords included in the keyword group and selects, from among the extracted communication contexts, the communication context similar to the topic; and acquiring, from the knowledge base, the recommended item linked to the selected communication context.

Even though the keyword extracted from the conversation is not included in an index of in information recommendation database, when the synonyms and the like thereof are included in the index of the information recommendation database, it is possible to search for information. Therefore, the present invention can solve the first problem described above and provide the information recommendation system, the information search device, and the information recommendation method that allow information to be searched for even when the keyword cannot be obtained directly from the conversation of the user.

It is preferable that the context extraction module of the information recommendation system according to the aspect of the present invention generates the keyword group after excluding some words from the synonyms of the keyword. General words widen a range of a search result to degrade accuracy of an information search. Accordingly, by excluding the general words from a thesaurus, it is possible to increase the accuracy of the information search.

It is preferable that the information recommendation system according to the aspect of the present invention further includes: a storage that stores the conversation of the user for a predetermined period, and the context extraction module extracts the keyword representing the topic also from the conversation of the user stored in the storage.

Even when the conversation is short, by causing a previous conversation to be included in a target for obtaining keywords, it is possible to extract the keyword included in the index of the information recommendation database. Therefore, the present invention can solve the second problem described above.

An aspect of the present invention is a program for causing a computer to function as the information recommendation device described above. The information recommendation device of the present invention can also be implemented by the computer and the program, and it is also possible to record the program on a recording medium and provide the program through a network.

Note that the individual aspects of the invention can be combined as much as possible.

### Effects of the Invention

The present invention can provide an information recommendation system, an information search device, an information recommendation method, and a program that allow a keyword to be indirectly (by using a multi-word searching technique, an associative searching technique, reference to a previous conversation, or the like) obtained and allow information to be searched for even when the keyword cannot be obtained directly from a conversation of a user.

### BRIEF DESCRIPTION OF DRAWINGS

FIG. 1 illustrates an example of a module configuration of an information recommendation system according to the present invention.

FIG. 2 illustrates an example of the module configuration of the information recommendation system according to the present invention.

FIG. 3 illustrates an example of a method of processing a context and a recommended item.

FIG. 4 illustrates a first example of a procedure example of recommended item generation processing.

FIG. 5 illustrates a second example of the procedure example of the recommended item generation processing.

FIG. 6 illustrates an example of processing of the recommended items and the contexts.

FIG. 7 illustrates an example of a structure of the recommended item and the context data.

FIG. 8 illustrates an example of an instance diagram of the recommended item and the context data.

FIG. 9 illustrates an example of an instance representation of the recommended item.

FIG. 10 illustrates an example of description of a recommended item search rule.

FIG. 11 illustrates an example of an instance representation of a keyword.

FIG. 12 illustrates an example of description of a keyword linked search rule.

FIG. 13 illustrates an example of a module configuration of the information recommendation system according to the present invention.

FIG. 14 illustrates an example of an information recommendation method according to the present invention.

FIG. 15 illustrates an example of a hardware configuration of the information recommendation system according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that, in the present description and the drawings, components that are denoted by the same reference numerals are equal to each other.

(Module Configuration)

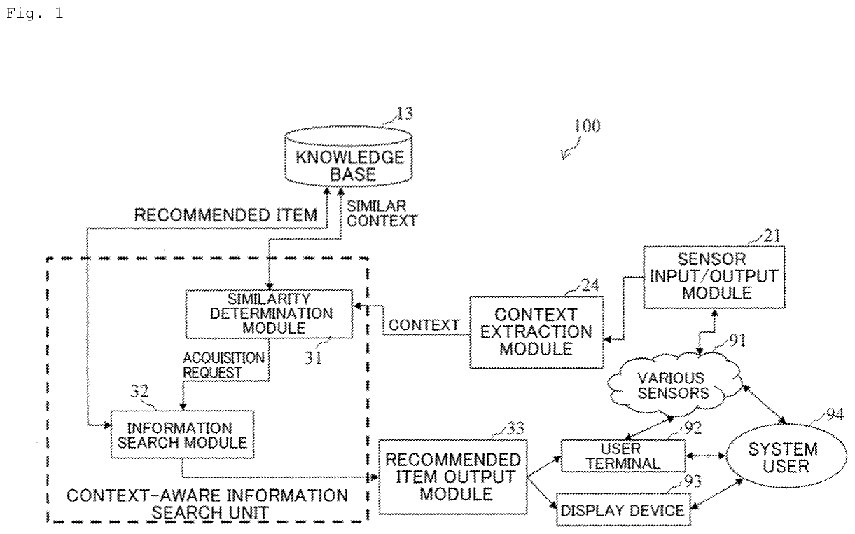

FIG. 1 illustrates a module configuration diagram of a first system according to the present disclosure. The system in the present disclosure includes a knowledge base 13, a context extraction module 24, a similarity determination module 31, and an information search module 32.

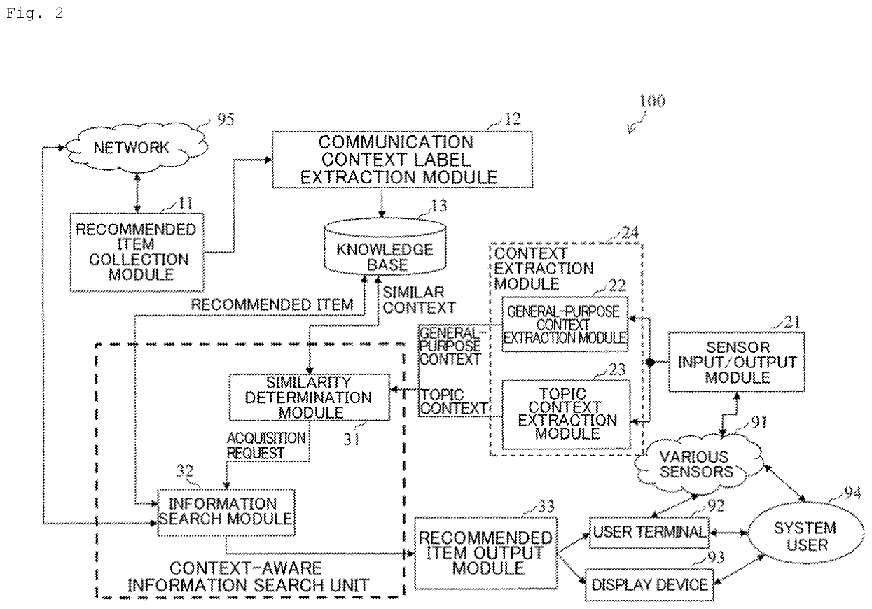

FIG. 2 illustrates a module configuration diagram of a second system according to the present disclosure. The second system in the present disclosure further includes, in addition to the first system, a recommended item collection module 11 and a communication context label extraction module 12. In addition, the context extraction module 24 includes a general-purpose context extraction module 22 and a topic context extraction module 23. A description will be given below of each of the configurations in the present disclosure.

The knowledge base 13 is a database prepared in advance, and stores sets of recommended items and contexts for a user 94. In the present disclosure, the context extraction module 24 extracts keywords each representing a topic, the similarity determination module 31 uses the keywords to extract, from the knowledge base 13, communication contexts appropriate for the topic, and the information search module 32 uses the extracted communication contexts to perform an information search.

It is to be noted herein that the keywords extracted by the context extraction module 24 may also include a keyword representing a situation in a conversation, such as a feeling. This allows the similarity determination module 31 to extract the communication contexts appropriate for the situation in the conversation. A source from which the communication contexts are to be extracted is not limited to the keywords in the conversation. For example, by preparing the general-purpose context extraction module 22 illustrated in FIG. 2, it is possible to use information from an optional sensor 91. Referring to a system configuration illustrated in FIG. 2, a description will be given below of the system in the present disclosure.

Each of the recommended items is for at least one of participants of the conversation, and may also be shared by two or more users. When the recommended item is shared by the two or more users, the knowledge base 13 may further store a user profile for identifying the user 94. This allows the recommended items appropriate for the user 94 to be provided.

To store the sets of the recommended items and the communication contexts in the knowledge base 13, the system in the present disclosure includes the recommended item collection module 11 and the communication context label extraction module 12. The recommended item collection module 11 automatically collects contents that may serve as the recommended items from the Internet or the like. The recommended items are any contents that can be acquired from a network 95, which are, e.g., news, videos, or addresses linked thereto. The collected recommended items are sent to the communication context label extraction module 12. The communication context label extraction module 12 determines the communication contexts of the recommended items and stores, in the knowledge base (KB) 13, the recommended items in conjunction with context labels associated with the recommended items.

To associate the context labels with the recommended items in the communication context label extraction module 12, any method can be used herein. For example, it is possible to use structured data according to ontology based on RDF (Resource Description Framework) and OWL (Web Ontology Language) (NPL 4 and 5). It may also be possible to store, in the knowledge base 13, a context rule based on SPIN (SPARQL Inferencing Notation) in combination (NPL 6 and 7).

Around the system user 94, the sensor 91, a display device 93 such as a display, a user terminal 92 such as a smartphone, and the like are disposed. The sensor 91 is one or more optional sensors including a microphone, a camera, a watch, and a thermometer. A sensor input/output module 21 acquires information from the sensor 91, and transmits required information to the general-purpose context extraction module 22 and the topic context extraction module 23.

For example, when the sensor 91 is the microphone that acquires voice data of the system user 94, the sensor input/output module 21 converts the voice data to text data, and outputs the text data to the topic context extraction module 23. At this time, the sensor input/output module 21 may also convert the voice data to feature values such as a sound volume, a sound quality, and a frequency component and output the feature values to the general-purpose context extraction module 22. When the sensor 91 is the camera that images a facial look of the system user 94, the sensor input/output module 21 outputs image data to the general-purpose context extraction module 22.

The general-purpose context extraction module 22 extracts, from sensor information obtained by the sensor input/output module 21, general-purpose contexts such as time information, environment information, location information of the user, video information such as the facial look of the user or a viewing media, a feeling analysis category, and a feeling analysis score. For example, the general-purpose context extraction module 22 uses at least any of the feature values including the sound volume, the sound quality, and the frequency component and obtained from the voice data and the facial look of the user included in the image to extract the feeling category and the feeling analysis score which are among the general-purpose contexts. The topic context extraction module 23 extracts, from a conversation of the user, a topic context representing a topic of the current conversation. The contexts obtained by the general-purpose context extraction module 22 and the topic context extraction module 23 are transmitted to the similarity determination module 31.

The similarity determination module 31 extracts, from among a plurality of keywords included in the received topic context, the keywords appropriate for the topic, and inquires of the knowledge base 13 to be able to acquire similar contexts as a list of the communication contexts similar to the topic context from among the communication contexts including the keywords. The similarity determination module 31 determines the similar contexts acquired from the knowledge base 13, and gives, to the information search module 32, a request to acquire the recommended items having the similar contexts determined to be required in the context labels.

For example, when a user A is talking to a user B about a movie the user A went to see yesterday, a conversational text “I went to see a movie in Shibuya last night, and it's Star Wars.” includes the four keywords “yesterday”, “Shibuya”, “movie”, and “Star Wars (the title of the movie)”. The “yesterday” belongs to a subordinate context of “Date”, the “Shibuya” belongs to a subordinate context of “Place Name”, and “Star Wars (the title of the movie)” belongs to a subordinate context of “Movie”. In this case, the similarity determination module 31 judges that when and where the movie was seen is not a center of the current topic, and determines that keywords “yesterday” and “Shibuya” belonging to the date and the place name have low similarities to the current communication context. As a result, the similarity determination module 31 determines that the two words “movie” and “Star Wars (the title of the movie)” have high similarity to the current communication context, and transmits a request to the knowledge base 13 to search for the similar contexts thereof.

Then, after the user A and the user B had continued the conversation on a topic related to the movie, the topic changed, and the user B said, “Speaking of Shibuya, there's a cafe that's going to open in July at Mark City, and I'd like to go there next time.” When the topic of the conversation was thus shifted, four keywords “Shibuya”, “Mark City”, “July”, and “cafe” are extracted from this conversational text. The “Shibuya” belongs to the subordinate context of “Place Name”, the “Mark City” and “cafe” belong to the subordinate context of “Place”, and “July” belongs to the subordinate context of “Date”. In this case, the similarity determination module 31 judges that the date is not the center of the current topic, and determines that the keyword “July” belonging to the date has a low similarity to the current communication context. As a result, the similarity determination module 31 determines that the three words “Shibuya”, “Mark City”, and “cafe” each having the “Place Name” and the “Place” as the superordinate contexts have high similarities to the current communication context, and transmits a request to the knowledge base 13 to search for the similar contexts thereof.

To search for the recommended items satisfying the acquisition request, the information search module 32 inquires of at least one of the knowledge base 13 and the network 95. The information search module 32 transmits the recommended items obtained as a search result to a recommended item output module 33. The recommended item output module 33 presents, to the user 94, the recommended items obtained from the information search module 32 via the display device 93, the user terminal 92, or the like.

The extraction or selection of the keywords or contexts in the similarity determination module 31 is performed herein by using a context hierarchy and a similarity of the superordinate context or the subordinate context. For example, the similarity determination module 31 calculates scores representing the similarities of the superordinate context and the subordinate context, and extracts or selects the contexts having the scores representing the high similarities. The extraction or selection may be performed by extracting or selecting the contexts having the scores not lower than a given score or by extracting or selecting a predetermined number of the contexts in order of descending score.

For the calculation of the scores, a typical cosine similarity can be used, or an item evaluation made by the user and stored in the knowledge base 13 may also be used. In the present embodiment, a set of an item keyword and a context keyword is prepared, but it does not necessarily mean that exactly the same keyword will be hit. Accordingly, it may also be possible that sets of similar words are stored in the knowledge base 13, and the similarity determination module 31 refers to the sets. In this case, the similarity determination module 31 can use semantic similarities in the sets of the similar words for the scores.

In the calculation of the scores, it may also be possible to use, in addition to the topic context obtained from a conversation of a current user, a context obtained from a conversation of a previous user. In the calculation of the scores, it may also be possible to use a similarity between the previous user and another current user. In such cases, a context obtained from the conversation of the previous user is stored in the knowledge base 13.

When the context obtained from the conversation of the previous user is to be used in the calculation of the scores, the recommended item collection module 11 and the communication context label extraction module 12 also determine the communication contexts for the conversation of the user in the same manner as for the recommended items, and stores the communication contexts in the recommended item/communication context label knowledge base 13.

### First Embodiment

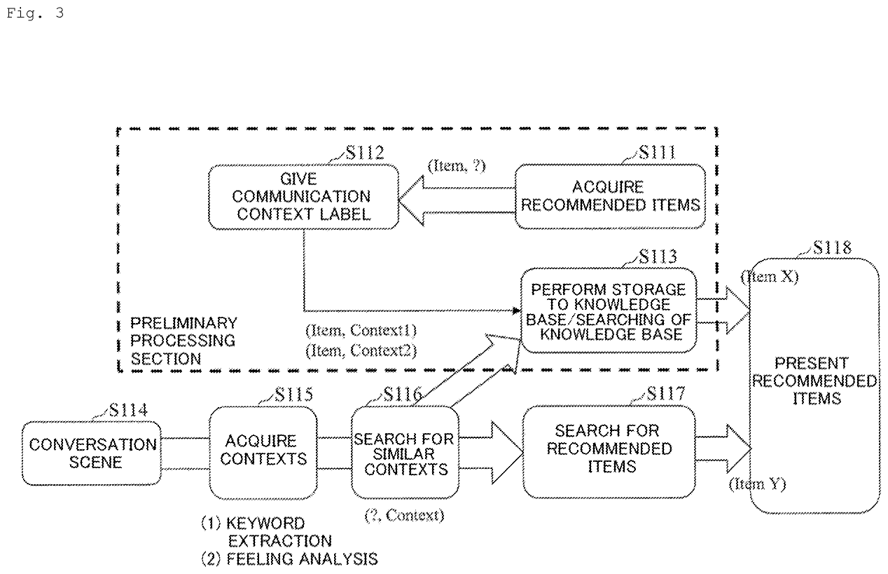

In the present embodiment, a description will be given of a method of processing the communication contexts and the recommended items. FIG. 3 illustrates a diagram illustrating the method of processing the communication contexts and the recommended items. Acquisition of the recommended items in S111, giving of the context label in S112, and storage of the context label in the knowledge base in S113 are performed prior to S114 to S118.

In the acquisition of the recommended items in S111, the recommended item collection module 11 acquires contents that may become candidates for the recommended items from the Internet or a content service in advance. In the giving of the communication context label in S112, the communication context label extraction module 12 performs keyword extraction, feeling analysis, and the like with respect to each of the recommended items to extract the communication context for the recommended item and give a label of the extracted communication context to the recommended item. Thus, a data set of the recommended item and the communication text corresponding thereto is stored in the knowledge base 13.

In a conversation scene in interpersonal communication in S114, acquisition of the contexts in S115 and retrieval of the recommended items in S116 are performed. In the acquisition of the contexts in S115, the topic context extraction module 23 analyzes text data to determine what topic is discussed in the conversation, and extracts the keywords. Thus, the topic is extracted as the keywords. For details of the conversation, the sensor 91 such as the microphone is used, the voice data is converted to the text data, and the keywords are extracted from the obtained text data.

In the acquisition of the contexts in S115, the general-purpose context extraction module 22 analyzes a feeling on the basis of a facial look of a person during the conversation, feature values of voice thereof, or the like to acquire the feeling analysis category and the feeling analysis score. For the facial look of the person, the sensor 91 such as the camera is used, and the feeling is analyzed through image recognition of the facial look of the person.

In the retrieval of the similar contexts in S116, the similarity determination module 31 uses the keywords, the feeling analysis category, and the feeling analysis score each thus obtained as the contexts, and searches for the sets of the recommended items and the contexts corresponding to the contexts. Thus, the similar contexts are obtained. The similar contexts mentioned herein may also include the general-purpose contexts such as general-purpose time information, environment information, location information of a user, and video information such as a facial look of the user or a viewing media.

In the retrieval of the recommended items in S117, the information search module 32 uses the similar contexts to search for contents of the Internet or the like or search the knowledge base 13 and obtain a recommended item search result. The recommended items obtained from the retrieval result are presented to the user 94 during the conversation (S118).

### Second Embodiment

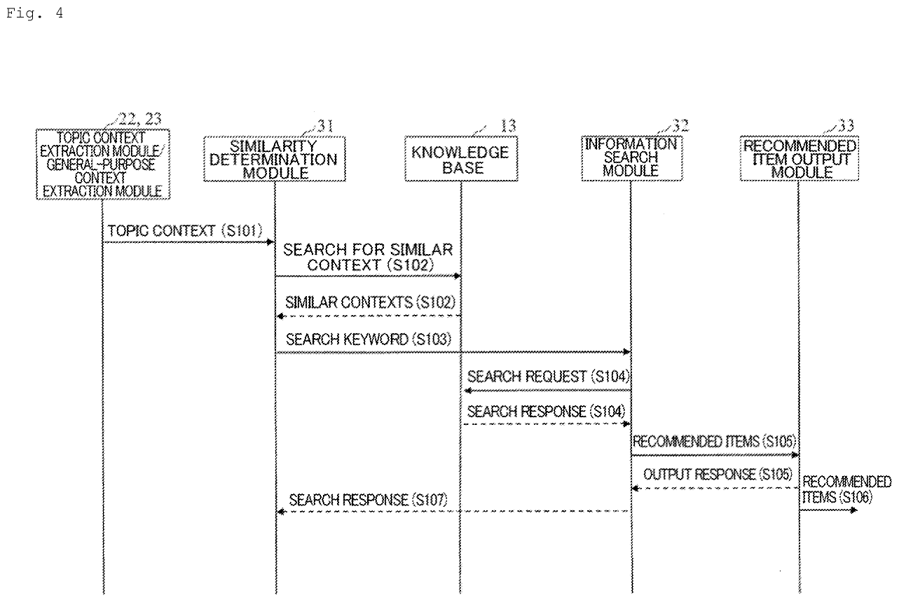

FIG. 4 illustrates a sequence diagram in a system according to the present embodiment. The system in the present embodiment searches the knowledge base 13 for contents.

The topic context extraction module 23 extracts, from a conversation of a user, the topic context representing a topic of the current conversation, and transmits the topic context to the similarity determination module 31 (S101). As a result, the topic context in the similarity determination module 31 is updated.

The similarity determination module 31 inquires of the knowledge base 13 about the similar contexts similar to the topic context (S102). As a result, the similarity determination module 31 obtains a response with a list of the similar contexts.

The similarity determination module 31 uses the obtained list of the similar contexts to generate a search keyword to be used to search for the recommended items and transmits the search keyword to the information search module 32 (S103). The generation of the search keyword is performed using a context hierarchy and a similarity of a superordinate context or subordinate context.

The information search module 32 transmits, to the knowledge base 13, the received search keyword as a request to search for the recommended items (S104). The knowledge base 13 returns, to the information search module 32, the recommended items matching the search keyword as a search response to the search request (S104).

The information search module 32 transmits the obtained recommended items to the recommended item output module 33 (S105), and the recommended item output module 33 presents the recommended items to the user 94 (S106).

The general-purpose context from the general-purpose context extraction module 22 is also transmitted to the similarity determination module 31, similarly to the topic context from the topic context extraction module 23 (S101). In this case, the similarity determination module 31 acquires the similar contexts each matching both of the topic context and the general-purpose context (S102).

### Third Embodiment

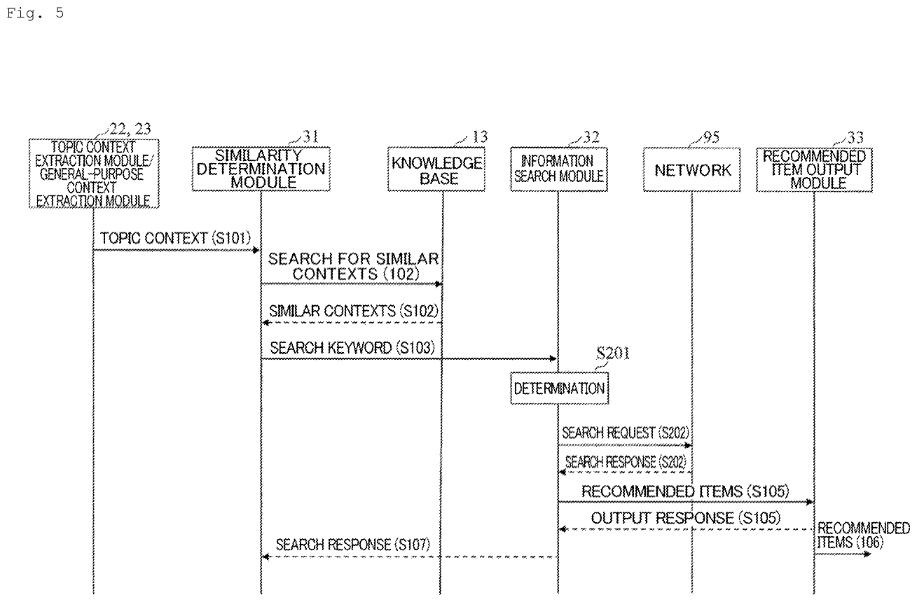

FIG. 5 illustrates a sequence diagram in a system according to the present embodiment. The system according to the present embodiment searches for contents of the Internet or the like.

A difference from the procedure illustrated in FIG. 4 is that the information search module 32 transmits a request to a network 95 having Internet contents, map information, and the like to search for the recommended items. When a proper noun or location information such as a place name or an area is included in the topic context, it may be preferable to search not the knowledge base 13, but the network 95. Accordingly, the information search module 32 analyzes the search keyword from the similarity determination module 31 to determine whether or not the network 95 is to be searched (S201).

When the network 95 is to be searched, the information search module 32 uses a predetermined search rule for extracting the proper name, the place name, the area, or the like to give a search request to the network 95 (S202). In this case, the information search module 32 determines whether or not the network 95 is a preferred one to be searched, and transmits the search request to the network 95 having a high possibility of holding appropriate contents.

Note that, when the search request is transmitted to the network 95, the information search module 32 may not only transmit the search request to the network 95 holding the contents (S202), but also transmit the search request to the knowledge base 13 (S104). Thus, in the present disclosure, it may be possible to transmit the search request to either one of the knowledge base 13 and the network 95 holding the contents, or may also be possible to transmit the search requests to both of the knowledge base 13 and the network 95.

### Fourth Embodiment

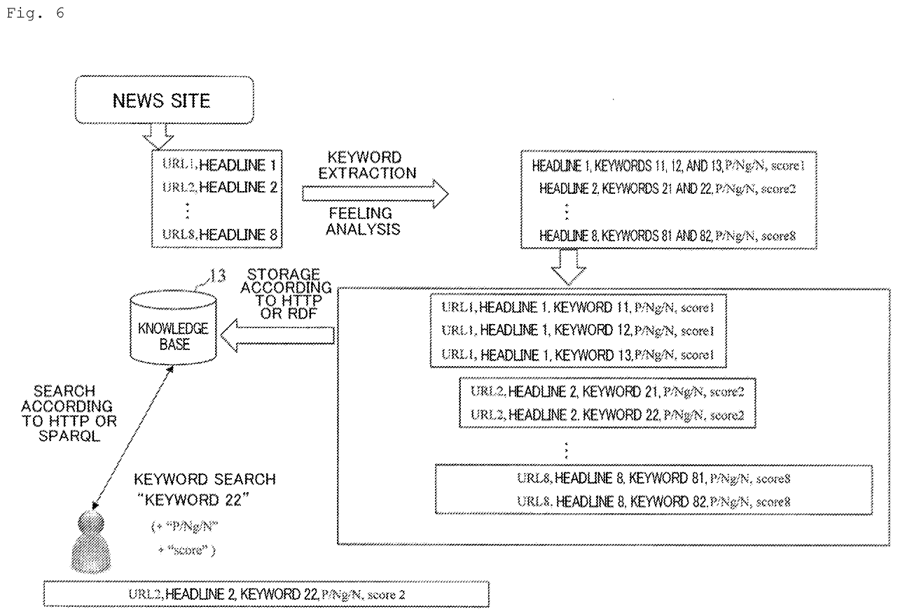

FIG. 6 illustrates an example of processing of the recommended items and the contexts that are stored in the knowledge base. In the present embodiment, the recommended item collection module 11 acquires, from a news site that provides news contents which may serve as the recommended items, URLs and headlines of news.

The communication context label extraction module 12 performs keyword extraction and feeling analysis with respect to the acquired headlines. The communication context label extraction module 12 stores, in the knowledge base 13, the URLs and headlines of the news, the extracted keywords, the feeling analysis categories, and the feeling analysis scores as structured RDF data. Thus, sets of the news contents serving as the recommended items and context labels including the keywords, the feeling analysis categories, and the feeling analysis scores and linked to the recommended items are stored in the knowledge base 13.

The feeling analysis category represents herein any one of categories “Positive” (P: Optimistic), “Negative” (Ng: Pessimistic), and “Neutral” (N: Neutral) into which details of each of the recommended items are classified. In the present embodiment, by analyzing the acquired headlines by natural language processing, it is possible to determine the feeling analysis category of each of the news contents. The feeling analysis score is a score obtained as a result of evaluating, for the obtained feeling analysis category, a level of a feeling analysis result by using numerical values from 0 to 1.

For data storage in the knowledge base 13, a protocol such as HTTP can be used. When it is intended to search the knowledge base 13 for the recommended items, searching is performed by inputting a specified search keyword in accordance with the recommended items to the knowledge base 13, and the recommended items matching the search keyword can be obtained as a search result.

Likewise, when the general-purpose context extraction module 22 analyzes a current feeling of a person during a conversation by using his or her facial look or the like, and a feeling analysis result belonging to the Negative category is consequently obtained for the person with a depressed facial look, to activate the conversation, the information search module 32 searches for recommended items belonging to the “Positive” category classified as a reverse feeling analysis category. Thus, the present embodiment allows the recommended items that activate the conversation to be successively represented in descending order of score.

The information search module 32 can also use, as the contexts, the time information, the environment information, the location information of the user, the video information such as the facial look of the user or the viewing media each acquired by the general-purpose context extraction module 22 to obtain the appropriate recommended items as a search result. For the searching of the knowledge base 13 for the recommended items, a protocol such as HTTP or a SPARQL query can be used.

### Fifth Embodiment

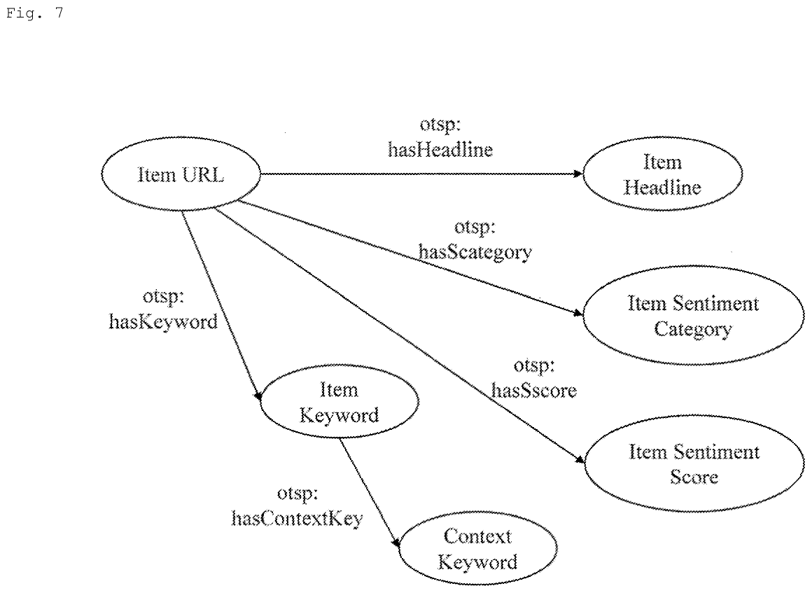

In the present embodiment, a description will be given of an example of a data structure and an example of description of the search rule in the knowledge base. FIG. 7 illustrates an example of a structure of the recommended items and the context data which are illustrated in FIG. 6. For the URL of each of the recommended items, the headline, the feeling analysis category, the feeling analysis score, and the keyword are stored. The keyword is, e.g., a keyword extracted from the headline. For the keyword, the context keyword related thereto may also be stored.

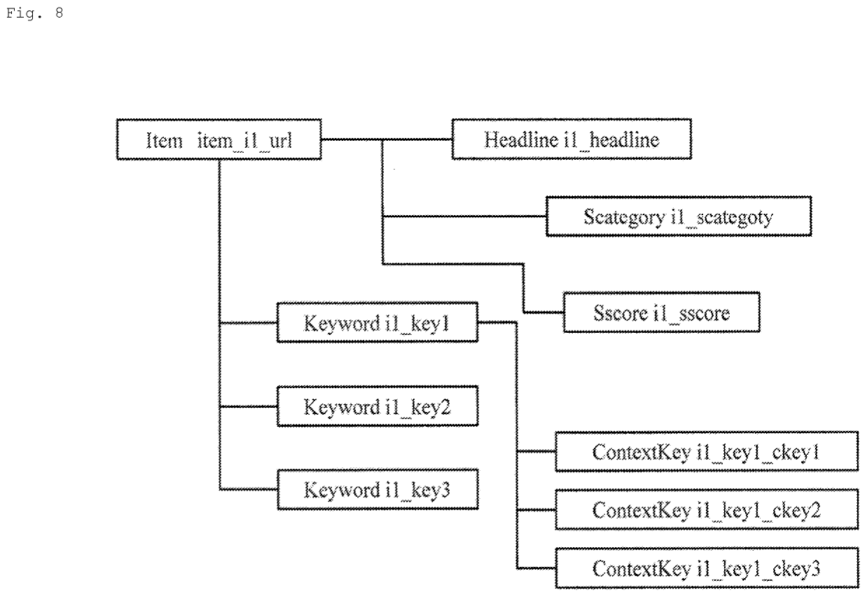

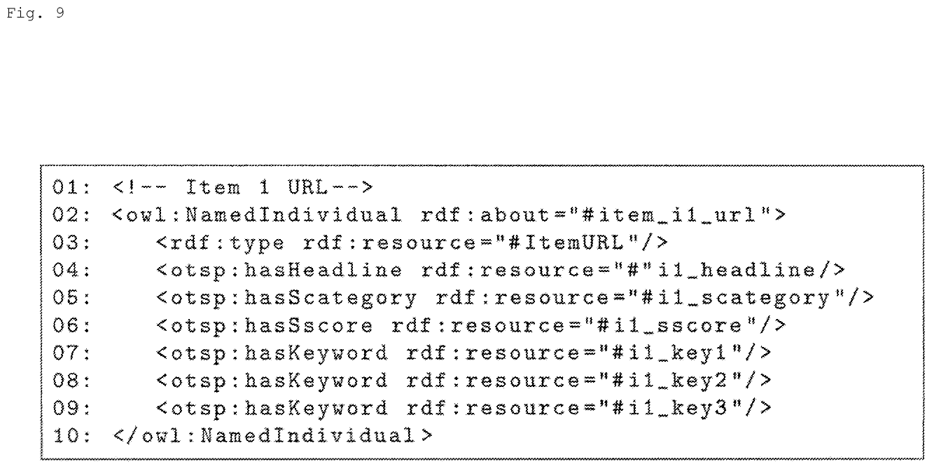

FIG. 8 illustrates an example of an instance generated on the basis of the data structure in FIG. 7. FIG. 9 illustrates an instance representation for a recommended item 1 illustrated in FIG. 8. The name of the instance is assumed to be item_i1_url. In the instance representation in FIG. 9, the instance in FIG. 8 is represented by owl.

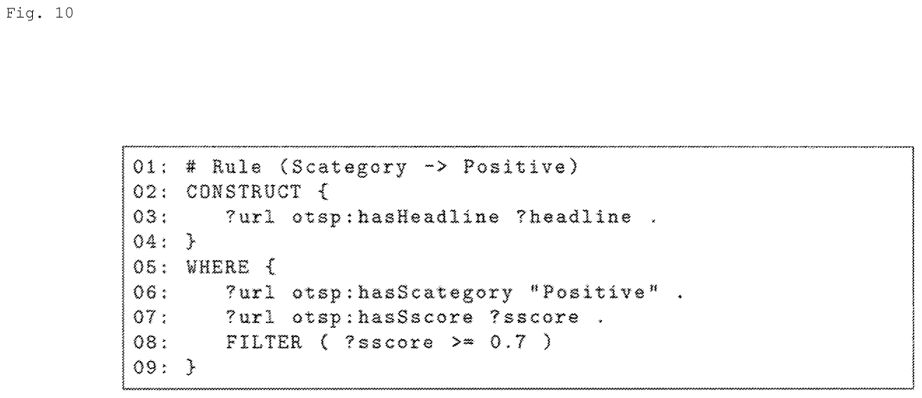

FIG. 10 illustrates an example of description of the rule when the recommended items are searched for. In this search rule, for those of the stored recommended items each having the feeling analysis category “Positive” and a feeling analysis score of 0.7 or more, a list of the URLs and headlines of the recommended items is obtained. When the recommended item consistent with the keywords included in the topic is searched for in the list thus obtained, it becomes possible to present the recommended item appropriate for the specified conversation. The data structure, the instance, the instance representation, and the description of the search rule each shown herein are exemplary, and another similar rule description can otherwise be made.

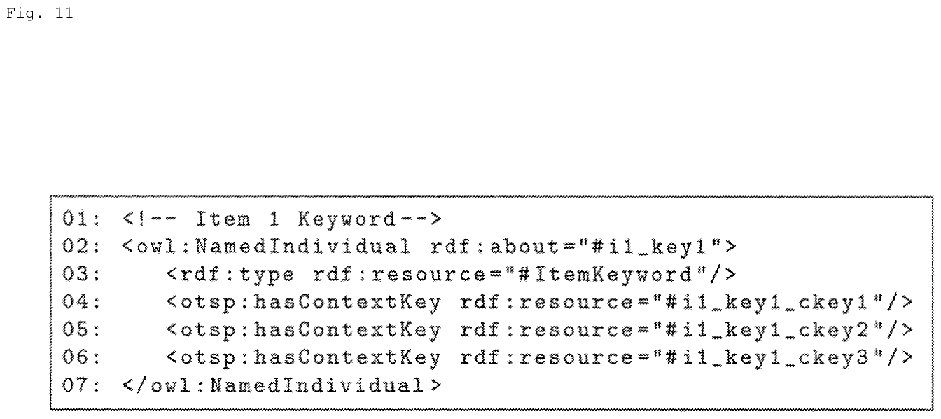

FIG. 11 illustrates an instance representation for the keyword. In the instance representation, it is shown that a keyword instance i1_key1 has context key instances i1_key1_ckey1, i1_key1_ckey2, and i1_key1_ckey3. It is assumed that the keyword instant and the context key instances are stored in the knowledge base 13 after consideration is given in advance to association therebetween.

By way of example, it is assumed that i1_key1 represents “trip”, i1_key1_ckey1 represents “domestic”, i1_key1_ckey2 represents “sea”, and i1_key1_ckey3 represents “Okinawa”. As shown in the procedure described above, the topic of the current conversation and the topic context information related to the topic can be obtained by extracting the keywords from details of the conversation.

When a user is having a conversation about “trip”, the topic context extraction module 23 extracts such keywords as “domestic” and “sea”. The keywords correspond to the topic contexts. The similarity determination module 31 uses “domestic” and “sea” as the topic contexts to search the knowledge base 13 for the similar contexts. As a result, the recommended item 1 including “Okinawa” as the keyword is extracted. The similarity determination module 31 outputs, to the information search module 32, a request to acquire the recommended items including “Okinawa” as the keyword. Consequently, the information search module 32 uses “Okinawa” as the keyword to search for the recommended items.

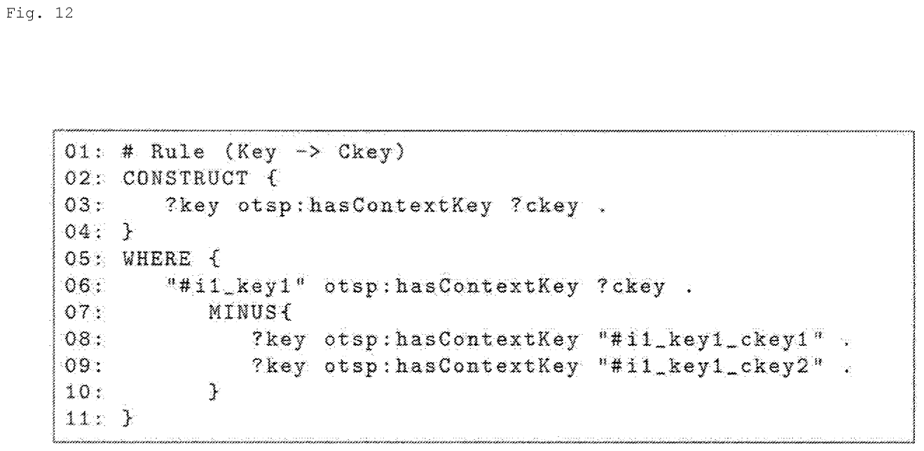

FIG. 12 illustrates a keyword linked search rule. In a case where the keyword instance i1_key1 has the context key instances i1_key1_ckey1, i1_key1_ckey2, and i1_key1_ckey3 under this rule, when the i1_key1_ckey1: “domestic” and the key1_ckey2: “sea” have already been extracted during the conversation, the information search module 32 can obtain, as a search result, the i1_key1_ckey3: “Okinawa” from the knowledge base 13 serving as the similar context.

The keywords in the similar contexts obtained by the similarity determination module 31 are used for the request to search for the recommended items, as described above. In this example, the topic in communication is provided as the topic contexts, while the environment information from the various sensors is transmitted/received using the sensor input/output module 21, and the required information is transmitted to the general-purpose context extraction module 22. This allows the general-purpose context extraction module 22 to extract, from the sensor information, general-purpose context information such as the time information, the environment information, the location information of the user, the video information such as the facial look of the user or the viewing media, or the feeling analysis category and also allows the information search module 32 to search for the recommended items, while taking also these information items into account. The data structure, the instance, the instance representation, and the description of the search rule each shown herein are exemplary, and another similar rule description can otherwise be made.

### Sixth Embodiment

It can be considered that, in the conversation scene, the recommended items to be presented are searched for while consideration is given to relations among participants in the communication. Accordingly, in the present embodiment, topic provision considering the relations among the participants in the communication and a result of feeling analysis based thereon is performed.

In the present embodiment, basic information and tastes and preferences of the participants in the communication and the relations among the participants are preliminarily stored as user profiles in the form of descriptions according to the RDF or the like in the knowledge base 13. In addition, user information that allows the participants to be identified is also registered as the user profiles in the knowledge base 13. The identification of the participants can be associated with the user profiles through image recognition based on preliminary registration of face images in the knowledge base 13 or on preliminary registration of voice data and feature values of the participants in the knowledge base 13. Thus, the similarity determination module 31 refers to the user profiles registered in the knowledge base 13 and thereby identifies the participants and the relations thereamong.

By way of example, when determining that a conversation is performed among people who have never met before, the similarity determination module 31 outputs, to the information search module 32, a request to acquire the recommended items belonging to the feeling analysis category “Positive”. When the conversation is performed between a married couple, there is a case where the similarity determination module 31 outputs, to the information search module 32, a request to acquire the recommended items belonging to the feeling analysis category “Negative” as well.

By using an example of a rule description when the recommended items are searched for illustrated in FIG. 10, the information search module 32 is allowed to present, depending on the relations among the participants in the communication, a list of the URLs and headlines of the recommended items each belonging to the feeling analysis category “Positive” and having a feeling analysis score of 0.7 or more or present a list of the URLs and headlines of the recommended items each belonging to the feeling analysis category “Negative” and having a feeling analysis score of 0.8 or more.

In this example, the relations among the participants in the communication are used as the general-purpose context information, and it is possible for the sensor input/output module 21 to transmit/receive the environment information from the sensor 91 and transmit the required information to the general-purpose context extraction module 22. This allows the general-purpose context extraction module 22 to extract, from the sensor information, the general-purpose context information such as the time information, the environment information, the location information of the user, or the video information such as the facial look of the user or the viewing media and also allows the information search module 32 to search for the recommended items, while taking also these information items into account. The data structure, the instance, the instance representation, and the description of the search rule each shown herein are exemplary, and another similar rule description can otherwise be made.

### Seventh Embodiment

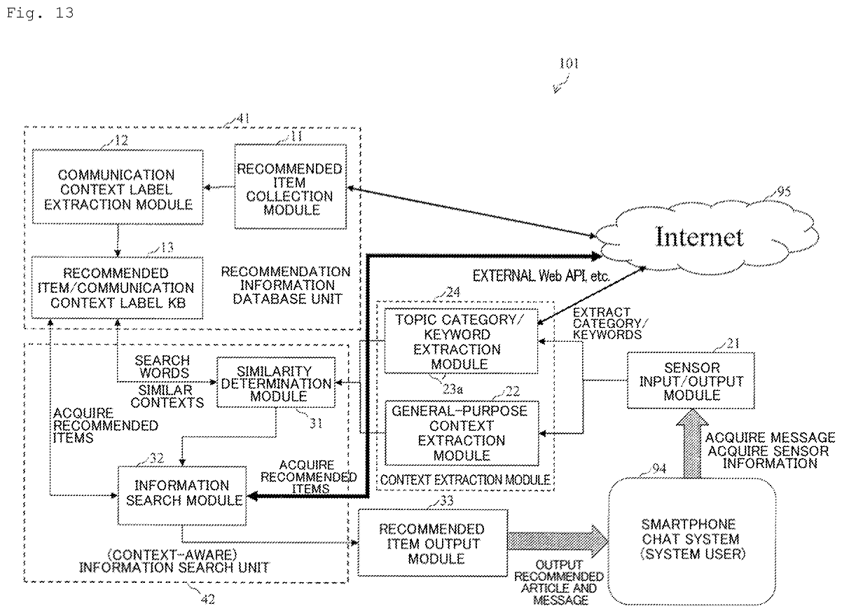

FIG. 13 is a module configuration diagram illustrating an information recommendation system 101 in the present embodiment. The information recommendation system 101 includes a recommendation information database unit 41, an information search unit 42, the context extraction module 24, the sensor input/output module 21, and the recommended item output module 33.

Specifically, the information recommendation system 101 includes: the knowledge base 13 storing recommended items linked to communication contexts each including a keyword; the context extraction module 24 that extracts, from a conversation of a user, the keyword representing a topic and searches a thesaurus database for the keyword to generate a group of keywords including synonyms of the keyword; the similarity determination module 31 that inquires of the knowledge base 13 about the keywords included in the keyword group to extract the recommended items and the communication contexts that are linked to the keywords included in the keyword group and selects, from among the extracted communication contexts, the communication context similar to the topic; and the information search module 32 that acquires, from the knowledge base 13, the recommended item linked to the selected communication context.

A difference between the information recommendation system 101 and the information recommendation system 100 described in the first to sixth embodiments is that the information recommendation system 101 has, as a substitute for the topic context extraction module 23, a topic category/keyword extraction module 23a.

Note that an information recommendation device described above includes the information search unit 42 and the context extraction module 24.

The recommended item collection module 11 automatically collects, from the Internet 95 or the like, contents that may serve as the recommended items. The collected content items are transmitted to the communication context label extraction module 12 and stored together with the context labels associated with the items in the recommended item/communication context label knowledge base (KB) 13. The KB 13 is formed as structured data according to the ontology based on the RDF (Resource Description Framework) and the OWL (Web Ontology Language) (NPL 2 and 3).

Additionally, in the KB 13, the context rule based on the SPIN (SPARQL Inferencing Notation) is stored in combination (NPL 4 and 5).

Around the system user 94, various sensors, a display device such as a display, a user terminal such as a smartphone, and the like are disposed. Environment information from the various sensors is transmitted/received by the sensor input/output module 21, and required information is transmitted to the context extraction module 24. The context extraction module 24 has the general-purpose context extraction module 22 and the topic category/keyword extraction module 23a. The general-purpose context extraction module 22 extracts, from the sensor information, general-purpose context information such as time information, the environment information, location information of the user, and the like. The topic category/keyword extraction module 23a extracts, from a conversation of the user, the context information related to the topic category and keywords of the current conversion. The context information items obtained by the general-purpose context extraction module 22 and the topic category/keyword extraction module 23a are transmitted to the similarity determination module 31.

The similarity determination module 31 extracts only the required context information items from among the plurality of received context information items. Note that “the required context information items” mean the context information stored in advance in the recommended item/communication context label KB 13. For example, the similarity determination module 31 preliminarily acquires the “required context information items” from the recommended item/communication context label KB 13 and removes the information items other than the “required context information items” from the context information items delivered from the context extraction module.

The similarity determination module 31 inquires of the recommended item/communication context label KB 13 about the required context information items and acquires a list of information items similar to the context information items and similar contexts. The similarity determination module 31 further determines the acquired similar contexts and transmits, to the information search module 32, the information items determined to be required. Note that the “information items determined to be required” are information items registered using the “similar contexts” as keys in the recommended item/communication context label KB 13, i.e., the information items corresponding to the required context information items described above.

To search for information satisfying the acquisition request, the information search module 32 inquires of the recommended item/communication context label KB 13 or the network 95. The recommended items obtained as a search result are transmitted to the recommended item output module 33. The recommended item output module 33 presents the recommended items to the system user 94 via the display device, the user terminal, or the like.

In the present embodiment, the following two operations different from those of the information recommendation system 100 described in the first to sixth embodiments will be described.

(1) Expansion of Search Words

In the topic category/keyword extraction module 23a, details of a conversation are analyzed, and keywords are extracted. As a typical keyword extraction method, there is a method using a morphological analyzer. A conversational text given as a text is decomposed into words or compound words to produce a list in order of frequency of appearance, and several words are used as keywords in descending order of frequency of appearance.

However, the keywords thus obtained may not necessarily be appropriate as search words for the recommendation information database unit 41. For example, when an index of the recommendation information database unit 41 does not include the search words, search results cannot be obtained and, when the search words are excessively general, accurate recommendation information in accordance with the conversation cannot be obtained. Accordingly, the topic category/keyword extraction module 23a uses the thesaurus to widen a range of the search words. The topic category/keyword extraction module 23a searches the Internet 95 or a thesaurus database not shown for the keywords obtained by analyzing the conversation as described above and produces lists of similar words/analogous words/related words (such as synonyms). The topic category/keyword extraction module 23a excludes general words (some words) from the lists, and then delivers the lists as the search words to the similarity determination module 31. The similarity determination module 31 uses the delivered search words (context information) to search the recommended item/communication context label KB 13 and obtain similar contexts. By thus expanding the search words, it becomes easier to obtain recommendation results.

Note that the “general words” mentioned above are words with which it is difficult to specify details (a topic) of communication, which are common nouns such as, e.g., “book” and “dog”. Conversely, “non-general words” are technical terms such as “regular matrix” and “quantum well”. The former one allows mathematics or information engineering to be specified as the topic, while the latter one allows physics or semiconductor engineering to be specified as the topic. The “general words” may also be proper nouns.

However, it is also possible to combine the general words with each other to specify the topic and extract the search words (context information). For example, when there are words “mountain”, “route”, and “rope” in communication, the topic category/keyword extraction module 23a can estimate that the topic is about mountaineering (by using a multi-keyword searching technique, an associative searching technique, or the like). In such a case, it is assumed that the topic category/keyword extraction module 23a does not exclude the “general words”.

(2) Adjustment of Conversational Text Length

The information recommendation system 101 further includes a storage (not shown) that stores a conversation of the user mentioned above for a predetermined period. The context extraction module 24 is characterized by extracting the keywords representing the topic mentioned above even from the conversation of the user 94 stored in the storage.

In general, in a conversation, one message uttered by a speaker is mostly short and an amount of information sufficient for analysis of the conversation cannot be obtained, and consequently keywords serving as clues for an information search may not be obtained at all. Accordingly, the messages previously uttered by the speaker are stored in a storage included in the sensor input/output module 21 or in a storage connected to the sensor input/output module 21. Then, the topic category/keyword extraction module 23a extracts keywords or a topic from a combination of a current conversation and the conversations stored in the storage mentioned above.

As keyword extraction methods, there can be considered two methods which are a method of going back a predetermined amount of time and summarizing conversation data up to the present to extract the keywords and a method of stepwise going back in time until sufficient keywords are obtained to extract the keywords. Since the keywords to be extracted are determined by the frequencies of appearance of words, the former method allows appropriate keywords to be more easily obtained. However, the topic may change with time and, when keyword extraction goes back excessively far in time, appropriate keywords cannot be obtained. Therefore, it is not preferable to excessively widen a range in which conversations are acquired.

Note that “until sufficient keywords are obtained” have the following two meanings. One of the meanings indicates “until a quantity of messages for obtaining at least one keyword is reached”. When no keyword is obtained, the similarity determination module 13 cannot search the knowledge base 13, and consequently the information search module 32 can recommend no information. Accordingly, the topic category/keyword extraction module 23a goes back in time until at least one keyword is obtained and incrementally continues to acquire messages. However, when there is a large time difference (e.g., half a day) between the messages in the storage, the topic category/keyword extraction module 23a determines that the topic has changed to a different topic and does not cause the previous topic to be included in a target for obtaining the keywords. When no keyword is thus obtained, the information recommendation system 101 recommends no information.

Another of the meanings is that, even when one or more keywords have already been obtained, “previous messages are further acquired until a high-accuracy keyword is obtained, and the obtained messages are used as analysis targets.” Accuracies of the keywords can be calculated using a method such as, e.g., TF-IDF. The topic category/keyword extraction module 23a stops acquiring previous messages when a keyword having a preset accuracy is obtained or the topic has changed (a large time difference is observed between the messages in the storage).

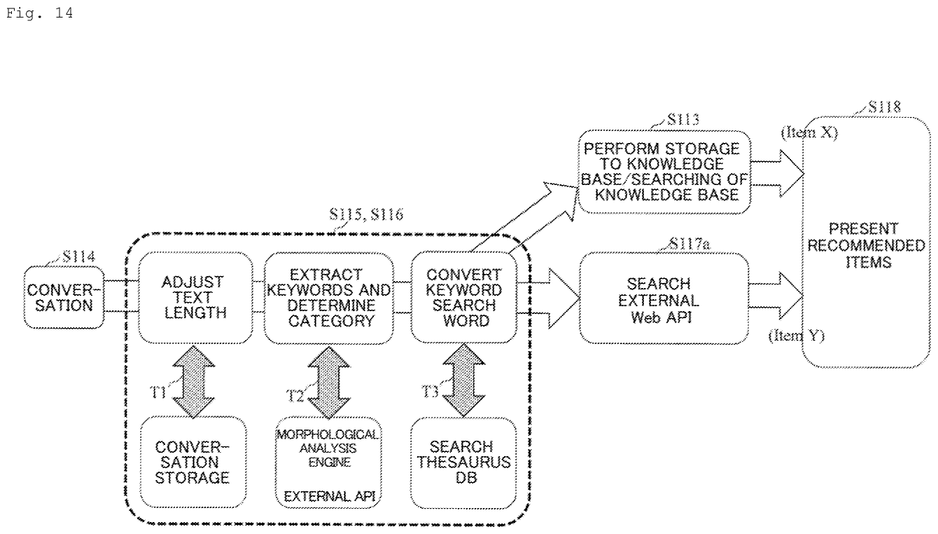

FIG. 14 is a processing flow illustrating an information recommendation method to be implemented by the information recommendation system 101. The information recommendation method includes: storing, in the knowledge base 13, recommended items linked to communication contexts each including a keyword; extracting, from a conversation of the user 94, the keyword representing a topic and searching a thesaurus database for the keyword to generate a group of keywords including synonyms of the keyword; inquiring of the knowledge base 13 about the keywords included in the keyword group to extract the recommended items and the communication contexts that are linked to the keywords included in the keyword group and selects, from among the extracted communication contexts, the communication context similar to the topic, and acquiring, from the knowledge base 13, the recommended item linked to the selected communication context.

A basic operation is the same as in the information recommendation method illustrated in FIG. 3, but the information recommendation method is different in an operation (bold broken line portion) of generating the search words from the conversation. By using the morphological analyzer described above, the keywords are extracted (Step T2) from the conversation (Step S114), and the category of the topic is determined. As illustrated in FIG. 3, it is also possible to directly use the keywords and perform searching by using the knowledge base 13 and a Web API for an information search on the Internet 95 (Steps S113 and S117a). However, in Steps S115 and S116, for more accurate information recommendation, the information recommendation system 101 widens a range of the search words by using also a thesaurus or previous conversations stored in the storage (Steps T1 and T3). By using the obtained search words, the information recommendation system 101 searches a database of the knowledge base 13 and Internet contents (Steps S113 and S117a) and presents search results as recommendation information (Step S118).

By thus generating the search words, the information recommendation system 101 is allowed to accurately extract the category and the keywords from the conversation of the user that does not necessarily have a large amount of information and increase the accuracy of the information recommendation.

### Ninth Embodiment

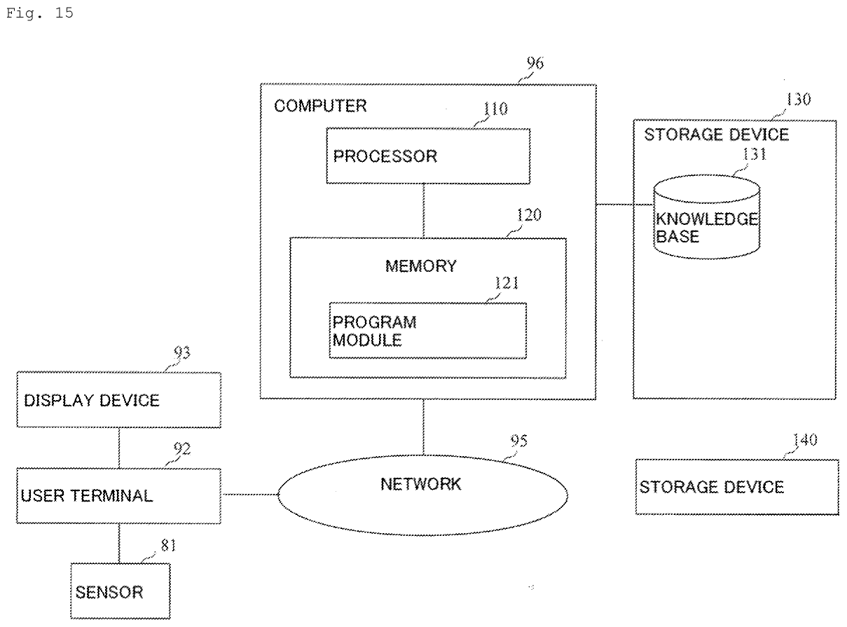

FIG. 15 illustrates an example of a hardware configuration of the system 100. The system 100 includes a computer 96 that functions as the information recommendation device according to the present disclosure. The computer 96 may also be connected to the network 95. The network 95 is a data communication network. Communication is performed using an electronic signal and an optical signal via the network 95.

The computer 96 includes a processor 110 and a memory 120 connected to the processor 110. The processor 110 is an electronic device formed of a logic circuit that responds to an instruction and executes the instruction. The memory 120 is a storage medium readable by the tangible computer 96 in which a computer program is encoded. In this respect, the memory 120 stores data and an instruction that are readable and executable by the processor 110 to control an operation of the processor 110, i.e., a program code. One of components of the memory 120 is a program module 121.

The program module 121 includes an optional module included in the present embodiment. Examples of the program module 121 include the sensor input/output module 21, the general-purpose context extraction module 22, the topic context extraction module 23, the context extraction module 24, the similarity determination module 31, the information search module 32, the recommended item output module 33, the recommended item collection module 11, and the communication context label extraction module 12.

The program module 121 includes an instruction for controlling the processor 110 such that the processor 110 executes the process described in the present description. While the program module 121 already loaded in the memory 120 is shown, the program module 121 may also be configured to be located in the storage device 140 so as to be loaded later into the memory 120. The storage device 140 is a storage medium readable by the tangible computer storing the program module 121. Alternatively, the storage device 140 may also be an electronic storage device of another type which is connected to the computer 96 via the network 95.

[Note]

The following is a description of the information recommendation system in the present embodiment.

(Tasks)

A first task is to obtain more accurate recommendation information by converting keywords extracted from a conversation of a user to synonymous words, analogous words, and related words (such as synonyms) and using these words as recommendation information database search words.

A second task is to cause, when a message length of one utterance of a speaker is short and an amount of information sufficient for keyword analysis cannot be obtained, a message previously uttered by the speaker to be included in an analysis target and thereby extract keywords and a topic with high accuracy.

### Solution

In the present information recommendation system, to widen a range of search words for a recommendation information database, a thesaurus database is used. A thesaurus is a type of synonym dictionary in which words are systematically classified according to synonymous relations, analogous relations, superordinate/subordinate concepts, and the like. From the thesaurus, the superordinate/subordinate concepts and synonymous/analogous words of the keywords can be obtained. By removing general words not representing details of the conversation from these and using the remaining words as search words for the recommendation information database, it is possible to obtain a larger number of search results more accurate than those obtained when only the original keywords are used as the search words.

When the message length of the speaker is excessively short and the keyword analysis is difficult, the message previously uttered by the speaker is also caused to be included in the analysis target, and then the keywords and the topic are extracted. There can be considered two methods which are the method of going back a predetermined amount of time, summarizing conversation data up to the present, and extracting the keywords and the method of stepwise going back in time until the keywords are obtained and extracting the keywords.

(Effect)

The present invention allows a category and a keyword to be accurately extracted from a conversation of a user not necessarily having a large amount of information, and can increase accuracy of information recommendation.

### REFERENCE SIGNS LIST

11 Recommended item collection module
12 Communication context label extraction module
13 Knowledge base
21 Sensor input/output module
22 General-purpose context extraction module
23 Topic context extraction module
23a Topic category/keyword extraction module
24 Context extraction module
31 Similarity determination module
32 Information search module
33 Recommended item output module
41 Recommendation information database unit
42 Information search device
91 Sensor
92 User terminal
93 Display device
94 User
95 Network (Internet)
a

1. An information recommendation system comprising:
a knowledge base storing recommended items linked to communication contexts each including a keyword;
a context extraction module that extracts, from a conversation of a user, the keyword representing a topic and searches a thesaurus database for the keyword to generate a group of keywords including synonyms of the keyword;
a similarity determination module that inquires of the knowledge base about the keywords included in the keyword group to extract the recommended items and the communication contexts that are linked to the keywords included in the keyword group and selects, from among the extracted communication contexts, the communication context similar to the topic; and
an information search module that acquires, from the knowledge base, the recommended item linked to the selected communication context.

2. The information recommendation system according to claim 1, wherein
the context extraction module generates the keyword group after excluding some words from the synonyms of the keyword.

3. The information recommendation system according to claim 1, further comprising:
a storage that stores the conversation of the user for a predetermined period, wherein
the context extraction module extracts the keyword representing the topic also from the conversation of the user stored in the storage.

4. An information recommendation device comprising:
a context extraction module configured to extract, from a conversation of a user, a keyword representing a topic and search a thesaurus database for the keyword to generate a group of keywords including synonyms of the keyword;
a similarity determination module configured to inquire of a knowledge base storing recommended items linked to communication contexts each including the keyword about the keywords included in the keyword group to extract the recommended items and the communication contexts that are linked to the keywords included in the keyword group and select, from among the extracted communication contexts, the communication context similar to the topic; and
an information search module configured to acquire, from the knowledge base, the recommended item linked to the selected communication context.

5. An information recommendation method comprising:
storing, in a knowledge base, recommended items linked to communication contexts each including a keyword;
extracting, from a conversation of a user, the keyword representing a topic and searching a thesaurus database for the keyword to generate a group of keywords including synonyms of the keyword;
inquiring of the knowledge base about the keywords included in the keyword group to extract the recommended items and the communication contexts that are linked to the keywords included in the keyword group and selecting, from among the extracted communication contexts, the communication context similar to the topic; and
acquiring, from the knowledge base, the recommended item linked to the selected communication context.

6. A non-transitory computer-readable medium having computer-executable instructions that, upon execution of the instructions by a processor of a computer, cause the computer to function as the information recommendation device according to claim 4.
